(19) United States
(12) Patent Application Publication
(10) Pub. No.: US 2011/0093478 A1
(43) Pub. Date: Apr. 21, 2011

(54) FILTER HINTS FOR RESULT SETS

(75) Inventors: Kimberly Starks, Fairfield, OH (US); Gregory Bishop, Cincinnati, OH (US); William Miller, Cincinnati, OH (US); Daniel Hollingsworth, Cincinnati, OH (US); Julian Gosper, Vancouver (CA)

(73) Assignee: Business Objects Software Ltd.

(21) Appl. No.: 12/581,708

(22) Filed: Oct. 19, 2009

(51) Int. Cl. G06F 17/30

(52) U.S. Cl. 707/754; 707/E17.076

(57) ABSTRACT

Systems and methods to provide filter hints for a result set are provided. In example embodiments, a search request is received and a search is initiated. Documents retrieved from the search are analyzed to determine filters, which may be organized into filter groups. A filter count for each filter is determined. The filter count indicates how many documents match the filter within a current result set or how many additional documents match the filter if selected. The current result set is a set of remaining documents based on any number of previously selected filters from any one or more filter groups being applied thereto. In example embodiments, the filters include enabled filters and any disabled filters, whereby the disabled filters have a zero filter count in the current result set. A visual indicator may also be provided to indicate at least one filter being selected within a collapsed filter group.

### FIELD

The present disclosure relates generally to lists, and in a specific example embodiment, to providing filter hints for result sets.

### BACKGROUND

Conventionally searching mechanisms may return results that are quite large. Some of these searching mechanisms may provide filters to reduce the results once all the results are received. However, a user using these filters does not know what effect applying filters will have in advance. Applying too many filters or filters with no overlap may return no results. As such, searching may be a slow and tedious process that may be frustrating to the user. Additionally, the selection of one filter may cause other filters to no longer be relevant and be removed from the filter list.

### BRIEF DESCRIPTION OF DRAWINGS

Various ones of the appended drawings merely illustrate example embodiments of the present invention and cannot be considered as limiting its scope.

FIG. 1 is a block diagram illustrating an example of an environment in which example embodiments may be deployed.

FIG. 2 is a block diagram illustrating an example embodiment of a search system.

FIG. 3 is a block diagram illustrating an example embodiment of an end-user engine.

FIG. 4a-FIG. 4c are example screen shots of a filter display section of a search result page while a search is proceeding.

FIG. 5 is an example screen shot of a result display using a match-all filter mode.

FIG. 6 is an example screen shot of a result display using a match-any filter mode.

FIG. 7 is an example screen shot of a result display illustrating filter visual indicators.

FIG. 8 is a flowchart of an example method to provide filter hints for a result set.

FIG. 9 is a flowchart of an example method to determine filters.

FIG. 10 is a flowchart of an example method to determine the filter hints.

FIG. 11 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Systems and methods to provide filter hints for a result set are provided. In example embodiments, a search request is received and a search is initiated. Results retrieved from the search are analyzed to determine filters. The analysis may be performed by applying advanced linguistics along with a predetermined rule set. The resulting filters may be organized into filter groups based a further rule set. While the search is proceeding, available results, filters, and filter groups may be provided to a requesting user device.

A filter count for each filter may be determined. The filter count indicates, prior to selection of the filter, how many results match the filter within a current result set or how many additional results match the filter if selected. The current result set is a set of remaining search results based on any number of previously selected filters from any one or more filter groups. The filter counts may be provided to the user device along with the corresponding filters for display in a filter display section on a display device. For example, rendering instructions may be provided to a browser associated with the display device. In example embodiments, the filters include enabled filters and any disabled filters, whereby the disabled filters have a zero filter count in the current result set. It should be noted that example embodiments may be used to filter any list of results regardless of whether the list is generated by a search.

In example embodiments, a collection of filter hints (e.g., filters, filter counts, filter categories, visual indicators) are provided to a user at the user device.

The filter hints provide the user with information that may be helpful to have prior to narrowing a result set. Using the filter hints, the user may combine filters together using Boolean operations (e.g., “or” or “and”) in a variety of permutations. This may be done while the search is being performed (e.g., dynamically) or upon completion of the search (e.g., statically). Additionally, the user may visually determine the outcome of combining filters prior to implementing the combination on the search results and have visual indicators of selected filters between various filter groups.

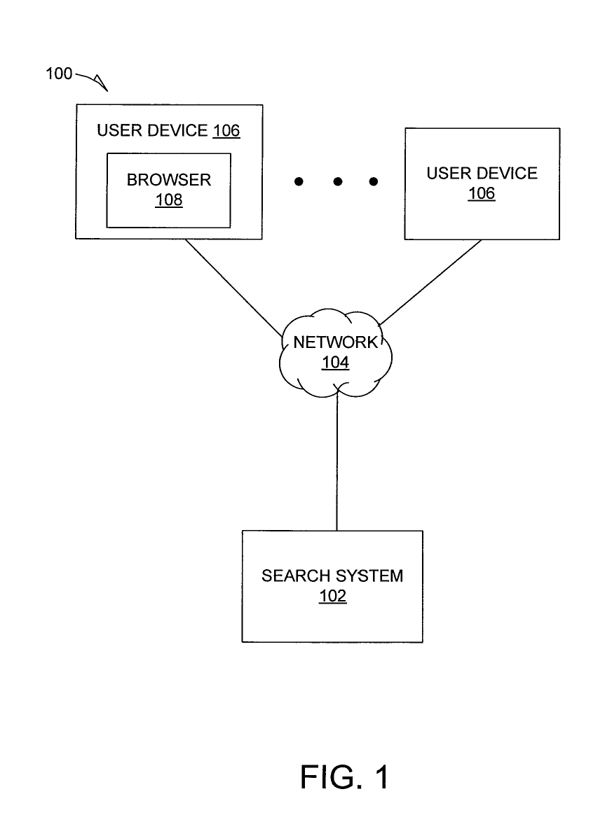

With reference to FIG. 1, an embodiment of an environment 100 in which example embodiments of the present invention may be deployed is shown. A search system 102 is communicatively coupled via a network 104 to any number of user devices 106. The network 104 may comprise any one or more of a local or wide area network (e.g., the Internet).

In example embodiments, the search system 102 receives a search request via a browser 108 associated with the user device 106. Search results are then obtained and returned to the requesting user device 106. However, because the search results may be quite large, the search system 102 further provides filter hints including filters, filter counts, and visual indicators, with the search results. The filters may comprise key words or attributes found in documents retrieved from performing the search that may assist the user in narrowing down the search results. The search system 102 as well as the various filters hints will be discussed in more detail hereinafter.

While not shown, the environment 100 may further comprise content providers and search brokers. The content providers provide some of the search result (e.g., documents) or provide access to some of the search result. Search brokers refer to sources that discover search results. For example, search brokers may be used to fetch results from external Internet search engines (e.g., Google), internal Internet sources, and internal databases. As used herein, search result, such as documents, may be any collection of information or data that may be of interest to a user at the user device. For example, the search result may comprise a whitepaper, a web page, a journal paper, a newspaper article, and so forth.

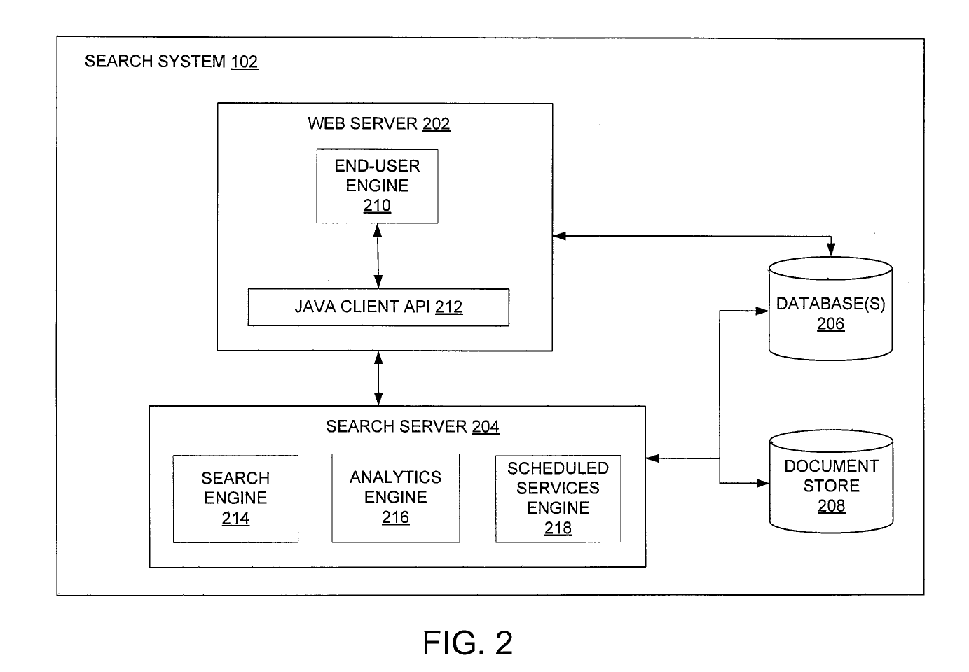

FIG. 2 is a block diagram illustrating an example embodiment of the search system 102. In example embodiments, the search system 102 comprises a web server 202, a search server 204, one or more databases 206, and a document store 208 all communicatively coupled together. While the web server 202 and the search server 204 are shown as two separate servers, alternative embodiments may combine components and functionalities of the web server 202 and search server 204 into a single server. In other embodiments, more than web server 202, search server 204, or document store 208 may be provided.

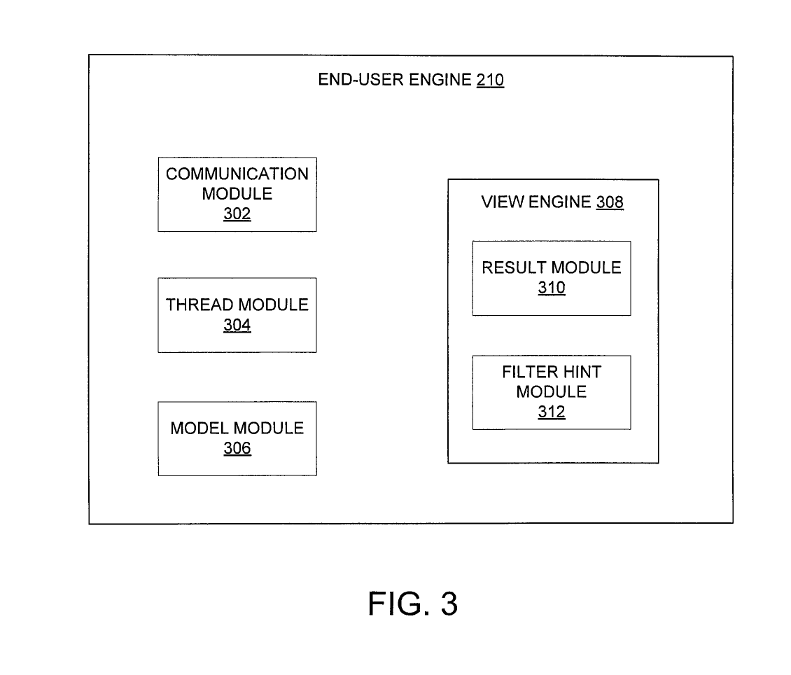

The web server 202 manages communications with the user device 106 as well as the search server 204 via an end-user engine 210. In example embodiments, the web server 202 receives a search request from a user device and forwards the request via a client API 212 to the search server 204. In response, search results and filters are received from the search server 204. The web server 202 then provides views of the search results and filters to the user device 106. The end-user engine 210 will be discussed in more detail in connection with FIG. 3.

The search server 204 performs searches, determines filters, and manages search alerts. In one embodiment, the search server 204 comprises a search engine 214, an analytics engine 216, and a scheduled services engine 218. Alternative embodiments may comprise more, less, or functionally equivalent components.

The search engine 214 manages searches. The search engine 214 receives the search request from the web server 202 and uses indicated search terms in the search request to perform the search. In example embodiments, the search is a federated search that simultaneous searches multiple databases, web resources, or any source having an API with which to be interfaced to find documents that match search terms of the search request. In one embodiment, the search engine 214 may use search brokers (e.g., standard or customized) that act as intermediaries between databases and web resources containing documents and the search engine 214. Search results may be obtained by the search engine 214 in the form of these documents.

The analytics engine 216 analyzes the results (e.g., documents returned as a result of the search) in order to determine filters. In example embodiments, the analytics engine 216 applies advanced linguistics against each returned document based on a rule set (e.g., ThingFinder SDK) in order to identify filters within the documents. The rule set may be customized by an administrator of the search system 102. The customization may include names and types of filters and filter groups that the administrator wants as results from the analysis. In one embodiment, the rule set may result in filters organized within filter groups including, but not limited to, category, company/organization, date, Internet address, measure, person, phone, place, product, social security number, source, and ticker symbol. Essentially, any attribute which may be of interest to a user may be established as a filter group using the rule set. Each filter group includes its own list of selectable filters, which can be applied to the search results as the search results are streamed in or when the search is completed. For example, under the company/organization filter group, filters such as Apple, Google, IBM, and Microsoft may be detected by the analytics engine 216.

In example embodiments, the analytics engine 216 starts analyzing documents as soon as results are returned to the search server 204. That is, the analytics engine 216 does not wait for the search to be completed, but analyzes as the search is proceeding. In some embodiments, the results to be analyzed are not based on a search (e.g., user wants to filter a stored set of documents). In these embodiments, the analytics engine 216 may retrieve the results and analyze the retrieved results.

The scheduled services engine 218 manages search alerts and page alerts that are run on a schedule. The page alerts may be set on web pages and are tracked by the scheduled services engine 218 for changes to the web pages. In example embodiments, the scheduled services engine 218 allows a search to be performed in background and notifies a user when new results are found.

The database(s) 206 stores information such as tables used by the web server 102 and the search server 204. In example embodiments, the web server 202 uses search information, results, and filters stored in the tables of the database(s) 206 to provide the filter hints.

The document store 208 is used by the scheduled services engine 218 for storage of documents and information retrieved while performing the schedule search. Because a collection of documents from the scheduled search may be quite large, the documents are stored on the document store 208 (e.g., file system) instead of the database(s) 206.

FIG. 3 is a block diagram illustrating an example embodiment of the end-user engine 210. In example embodiments, the end-user engine 210 provides the results and the filter hints to the user device 106. The end-user engine 210 comprises a communication module 302, a thread module 304, a model module 306, and a view engine 308 including a result module 310 and a filter hint module 312.

The communication module 302 manages communications between the end-user engine 210 and other components in the environment 100. In some embodiments, the communication module 302 receives a search request from the browser 108 associated with the user device 106. Alternatively, the communication module 302 may receive a request to filter an existing result set (e.g., a set of documents previously stored to a database). Once the request is received, one or more of the thread module 304, model module 306, and the view engine 308 may generate a search thread, a model, and views into the model, respectively. The search thread communicates with the search server 204 to submit the search request.

The model is a representation of the data returned by the search server 204. In example embodiments, the model implements an observer interface that the search thread module 304 registers with the search server 204. The model may store the data in a manner that is specific to the end-user engine 210. Every time a new or updated search result is discovered, the search server 204 communicates the new information through the observer interface to the model. As a result, the model is updated by the model module 306 with the new information. The model, thus, contains information that drives filter hints on the user device 106. Each view may register change listeners with the model. When new information is updated in the model, a change notification may be sent to all registered change listeners. Subsequently, state information is updated in the views.

The views provide a logical view into the model, and stores state specific information that may be used to recreate or query into the model. The views may comprise a result view and a filter view. The result view module 310 manages a result view which is responsible for organizing a result list. The result view may comprise information, such as, what results have a checkbox selected, how many results per page to show, what page of result is the user currently viewing, and so forth. This information may then be used to query into the model to obtain a result set to be rendered on the user device.

The filter hint module 312 manages a filter view that may be responsible for organizing the filters into logical filter groups for display. The filter view may comprise information, such as, what filters belong to which filter group, which filters are selected in each filter group, or setting of each filter groups mode (e.g., match-any or match-all). The filter view also stores filter updates. For example, every time a user changes a state of a filter (e.g., selects a filter), the filter view is updated and responds with an array of Boolean values that specify a state (e.g., whether any filters are selected) for each filter group. The information from the filter view may be used to determine which filters to fetch from the model to be rendered on the user device when a filter group is expanded. The information is further used to calculate the various filter hints that are rendered on the user device.

In example embodiments, the filter hint module 312 retrieves filter information and determines filter hints to be provided to the user. In example embodiments, the filter hint module 312 calculates result counts for each filter in each filter group. Because the documents may be analyzed while the search is still being processed, the result counts will change as new search results are obtained. The result counts are used by the view engine 308 to update the views.

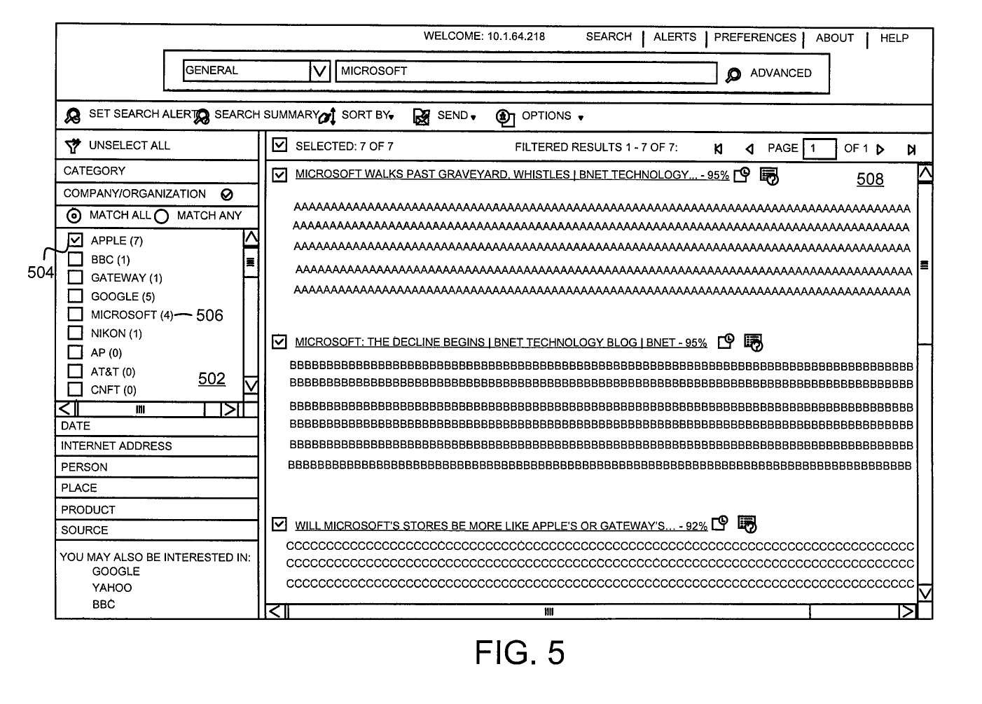

The calculations performed depend on a mode of the current filter group along with any currently selected filters. If no filters are currently applied to a result set or if a match-all mode (as will be discussed further below) is applied, then the filter hint module 312 calculates a number of documents within the current result set that contain each filter. However, if a match-any mode (as will be discussed further below) is applied, the filter hint module 312 calculates a number of documents in a current result set that contain each filter and a corresponding total number of documents in a total result set that contain each filter. The total result set is a result set not having any filters applied thereto. Example of various result counts and their associated calculations will be discussed in more detail with reference to FIG. 5 to FIG. 7.

In one embodiment, the views may then be polled by the browser 108 and used to update a result display provided to the user by the browser 108. In example embodiments, the browser 108 maintains a poll interval to query the end-user engine 210 for updates that should be rendered on the user device 106. The updates may be received in the form of rendering instructions in accordance with one embodiment. In alternative embodiments, the results and filter hints may be pushed (e.g., via rendering instructions) to the user device by the web server 202.

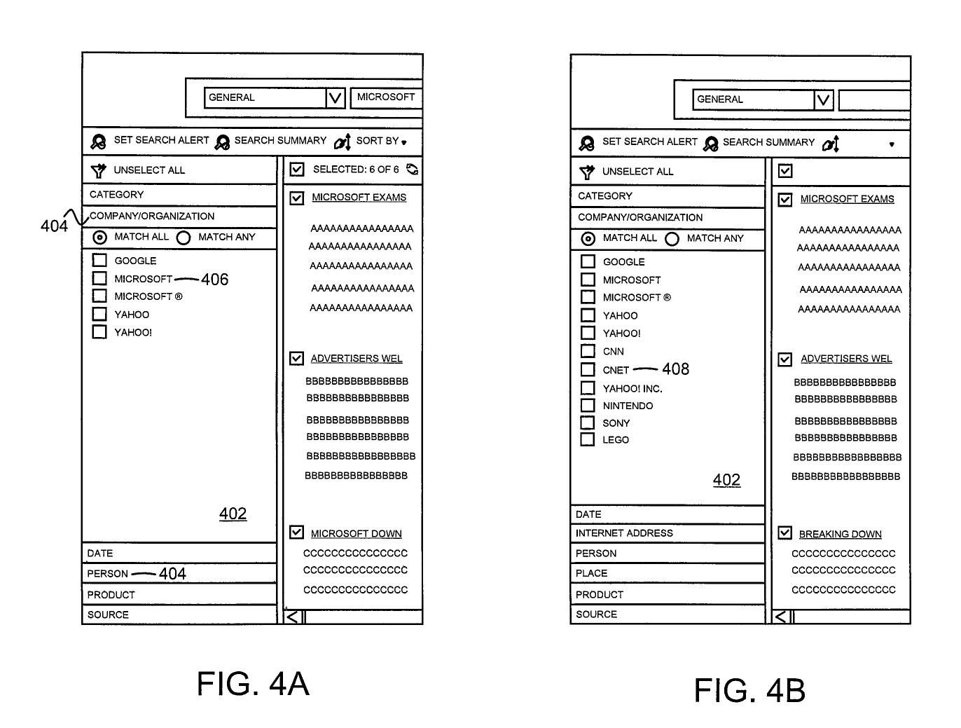

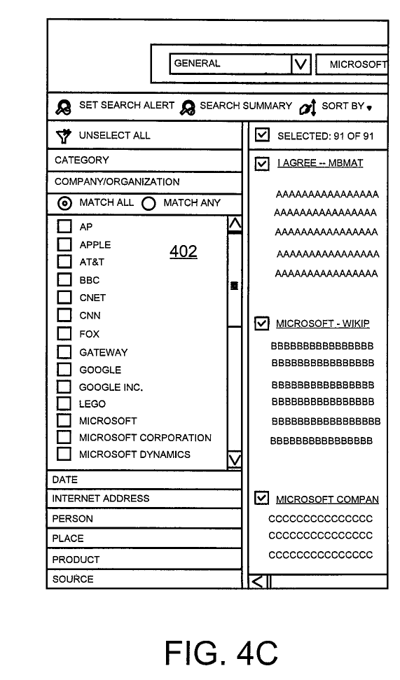

FIG. 4a-FIG. 4c are example screen shots of a filter display section 402 of a search result page displayed to a user via the browser 108 while a search is running (e.g., the right side of the search result page is not shown in its entirety). A single search may generate thousands of filter items for a single filter group. To balance usability with performance, especially when search results are still streaming to the user device 106, a user can view (e.g., expand) one filter group 404 at a time in accordance with one embodiment. As shown in FIG. 4a, an initial list of filters 406 within a company/organization filter group 404 is expanded for display in a filter display section 402. If auto-sorting is set on, the list of filters in the filter group 404 may be organized based on a sorting preference. Sorting preferences may include, for example, alphabetically or by descending number of results for each filter. The remainder of the filter groups (e.g., category, date, person, product, and source) are in a collapsed state.

As search results stream in, new filters 408 in the expanded filter group 404 are added to a bottom of the filter list in the expanded filter group 404. As shown in FIG. 4b, six new filters 408 (e.g., CNN, CNET, Sony) are added to the bottom of the company/organization filter group 404. This prevents the content of the display from constantly jumping and causing the user to have to chase a specific filter to select the filter. If auto-sorting is on, the filter list is periodically sorted resulting in the filter display section 402 as depicted in FIG. 4c.

While the search is proceeding, result counts are not provided for each filter in the expanded filter group. However, once the search is completed, the result counts may then be displayed. Referring now to FIG. 5, a filter display section 502 is illustrated with a list of filters. Each of the filters is preceded with a selection checkbox 504 and followed by a result count 506 enclosed in a parenthesis. The result count is a total number of results in a current set of results illustrated in a result section 508 that match the filter. For example, the current set of results, as illustrated, contains seven documents that include the filter “Apple.”

In the example of FIG. 5, the checkbox for “Apple” has been selected. As such, the results section 508 shows documents that contain the Apple filter. Additionally, filters that when combined with the selected filter(s) (e.g., Apple) will result in an empty result set are disabled and moved to the bottom of the filter list. For example, AP, AT&T and CNET are disabled filters shown at the bottom of the filter list. The disable filters are not selectable and may be greyed out or otherwise graphically distinguished to indicate that the filters are disabled. By sorting disabled filters to the bottom of the filter list, a user can quickly and easily locate valid filters and understand what is and is not included in the current result set displayed in the result section 508.

By disabling filters, instead of removing filters, users are aware of what happened to various filters. This allows the user to have knowledge of what filters were available without having to clear the currently selected filters or unselecting one or more individually selected filters. Furthermore, if a disabled filter were removed from the filter list, the user may incorrectly assume that no documents were originally found containing that particular filter.

Additionally, knowing that particular filters are not combinable may yield important information in itself. This may be especially true when selecting filters from different filter groups. For example, a user sees filter A in filter group 1, selects filter X in filter group 2, and returns to filter group 1 to discover that filter A is now disabled. Thus, the user knows that there is no document having a combination of filter A and X, but that there were originally documents that contain filter A.

In example embodiments, two different modes for combining filters are provided by example embodiments of the present invention. A first mode is a match-all mode, which results in using a Boolean operator “AND” to combine selected filters. Because the match-all mode specifies that filtered results match-all of the selected filters, the match-all mode effectively reduces the result set.

For example and referring to FIG. 5, a completed search result may comprise 50 documents or results. A filter hint indicates “Apple (7).” This means that seven of the 50 original documents match the filter Apple (e.g., contain the filter item “Apple”). When the user selects “Apple” as a filter and is in the match-all mode, the current result set (e.g., filtered results) now contains seven documents. However, the original result set still contains 50 documents.

The expanded filter group is updated with result counts for the remaining enabled filters. Thus, for example, there is one document that contains both “Apple” and “BBC” filter items—the actual filter word in the document, while there are five documents that contain both “Apple” and “Goggle” filter items. Furthermore, no documents contain both “Apple” and “AT&T” filter items.

A second mode for combining filters is a match-any mode. The match-any mode starts by narrowing the result set with a first selected filter, but as the user selects more filters, the result set will grow. That is, selected filters are combined using a Boolean operator “OR.” Therefore, the result set comprises documents that match at least one of the selected filters.

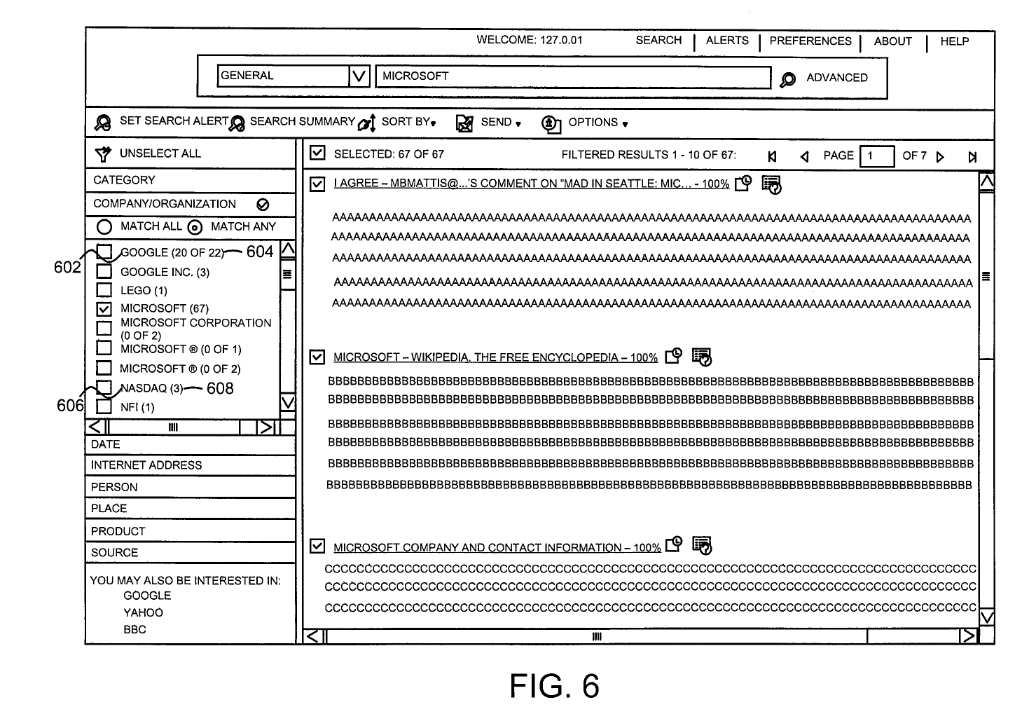

Referring now to FIG. 6, a screen shot of a results display is shown using a match-any mode for combining filters. Assuming that the completed search returned 100 documents, the user selection of the filter “Microsoft” reduces the original result set to 67 documents as shown. The “Google” filter 602 is shown with a result count 604 of “(20 of 22).” The first number of the result count 604 (e.g., 20) represents a number of matching results within a current result set (e.g., the 67 documents having Microsoft filter items), while the second number of the result count 604 (e.g., 22) represents a total number of results that will be displayed if the filter is selected (e.g., based on the original 100 documents) that will match the filter item. This means that 20 of the 67 documents in the current result (that contain the filter item “Microsoft”) set contain the filter item “Google,” while 22 of the original 100 returned documents contain the filter item “Google.” Thus, if the user further selects the “Google” filter 602 then the result set expands to 69 with an addition of the two new documents that contain the filter item “Google” but not “Microsoft.”

The “Nasdac” filter 606 is shown with a result count 608 of “3.” This indicates that three of the documents in the current result set (e.g., the 67 documents containing “Microsoft”) contains the filter item “Nasdac.” However, there is no second number in the result count 608, which indicates there are no additional documents from the original result set that contains the “Nasdac” filter 606. Therefore, the further selection of the “Nasdac” filter 606 will not change the result set.

As such, when a user accesses search results, the user may select a mode within a filter group to apply to the filters of the filter group, and select one or more filters within the filter group. The user may further select filters from other filter groups; thus combining filters from different filter groups. The filter hint module 304 takes the one or more filters within each filter group and applies the selected mode. Furthermore, the filter hint module 304 applies a Boolean “AND” operation (e.g., match-all) across filter groups. For example, a user can combine filters using a match-all mode in the organization/company filter group, while combining filters using a match-any mode in a person filter group. The final filtered result set will then combine the results for the two filter groups using a match-all mode. Thus, the final filtered result set will comprise documents that contain filter items matching all of the selected organization/company filters and any of the selected person filters.

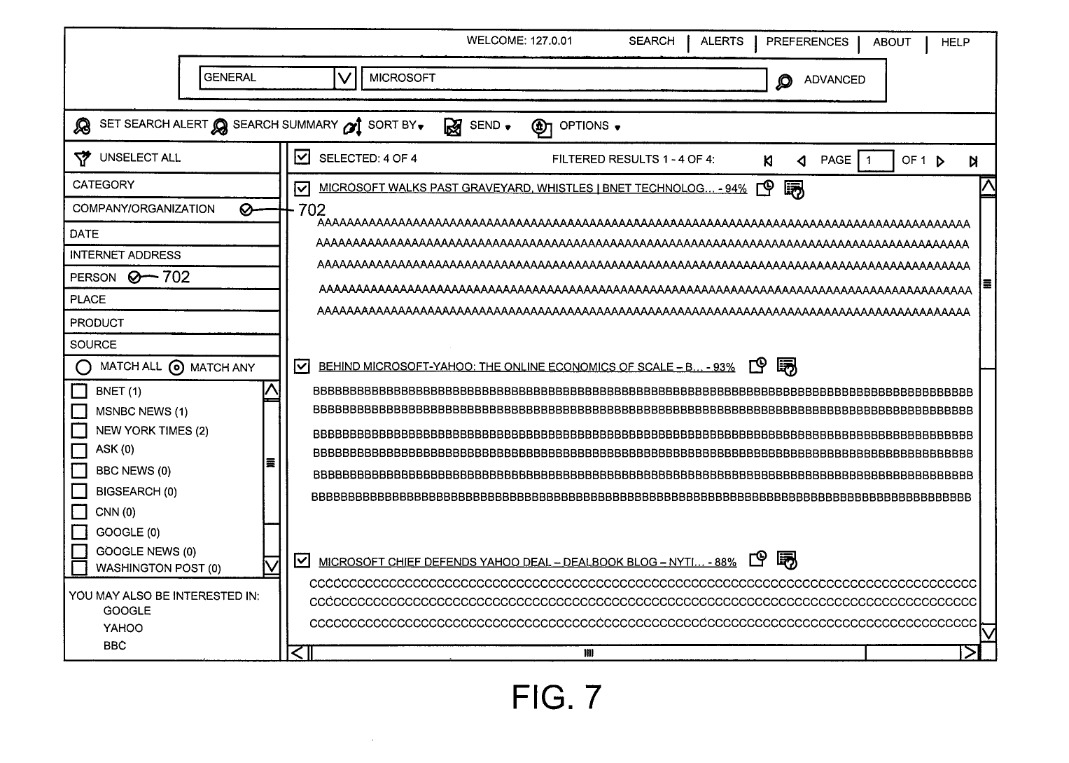

FIG. 7 illustrates a further filter hint provided by embodiments of the present invention. Because a user is able to select one or more filters within multiple filter groups, a visual indicator is provided to indicate selected filters in collapsed filter groups. As shown, for example, checkmarks 702 are provided to indicate that at least one filter has been selected in the filter group “Company/Organization” and “Person,” while the user expands a “Source” filter group. Therefore, a user has a general idea of the various filters that are applied to a result set without having to manually access every filter group to determine which filters are selected.

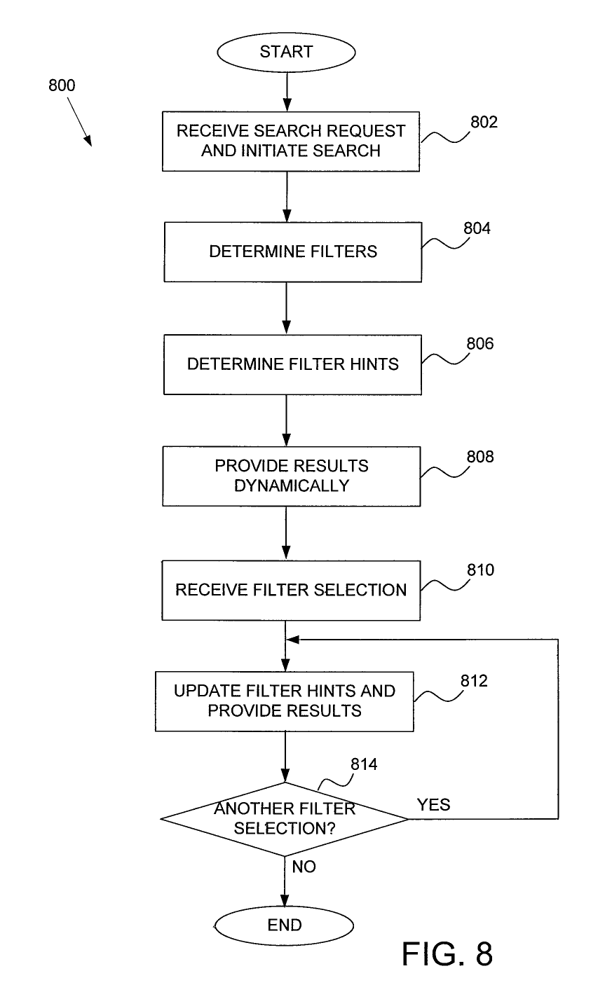

FIG. 8 is a flowchart of an example method 800 to provide filter hints for a result set. At operation 802, a search request is received. As a result, a search is initiated using search terms provided in the search request. In example embodiments, the communication module 302 receives the search request and forwards the request onto the search server 204. The search engine 214 of the search server 204 then performs the search. In one embodiment, search brokers may be used by the search engine 214 to obtain search results.

Filters are determined in operation 804. In example embodiments, the analytics engine 216 applies advanced linguistics along with a rule set to identify filters items found in documents retrieved by the search. These filter items collectively indicate one or more filters. The filters items and filters may be stored to a table of a database (e.g., database 206) or cached for the current search session.

Filter hints are determined in operation 806. The filter hint module 304 calculates filter counts for a current set of results. In one embodiment, the calculations are used to update a filter view by the view module 308. The calculations may also update a table of a database (e.g., database 206) or be cached.

At operation 808, results of the search are dynamically provided to the requesting user device 106. In example embodiments, the search server 204 provides search results as the search is progressing to the web server 202. For example, the filter view may be accessed for updates when the browser 108 of the user device 106 polls the web server 202 for search results. Alternatively, the search results may be pushed to the client device.

At operation 810, a filter selection is received from the user device. The filter selection updates the results displayed in the result section on the user's browser. In example embodiments, a user selection of a filter from a filter group is received by the communication module. The user may also indicate whether the filtering for the filter group should be performed in a match-all or match-any mode.

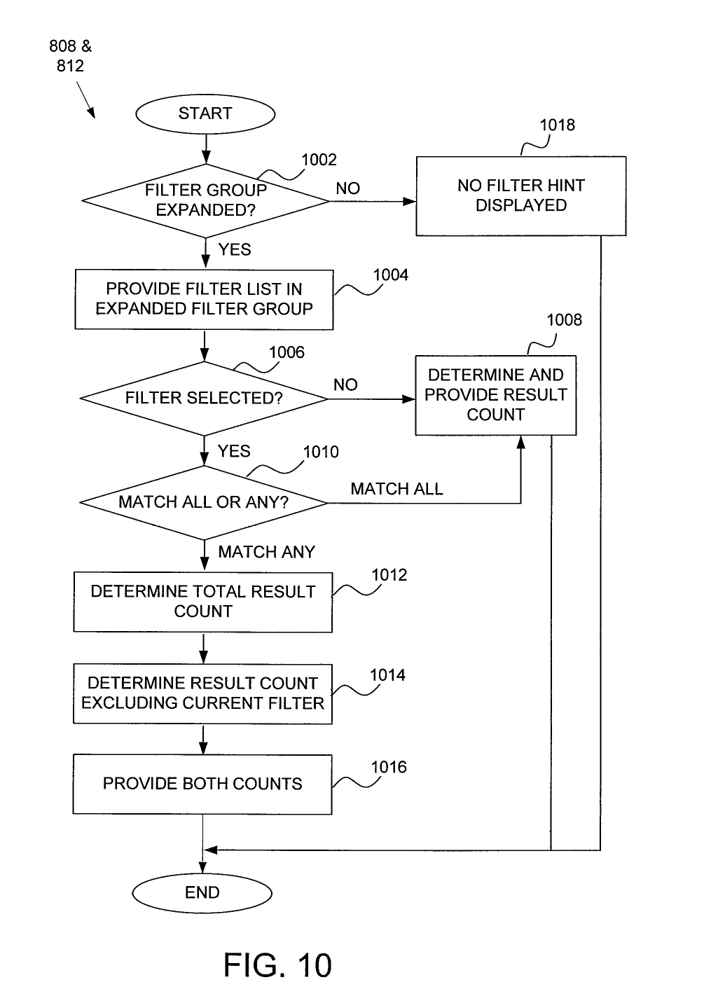

Using the filter selection, the filter hints are updated and results provided to the user in operation 812. In example embodiments, the filter hint module 304 calculates new result counts for the filters taking into account the selected filters. For example, new SQL statements may be run against the database to retrieve data that provides the new filter counts based on the selected filter. Thus, the views may be updated accordingly. Rendering instructions for providing a visual indicator may also be generated. The updated filter hints may then be provided to the user device 106. Operation 812 will be discussed in more detail in connection with FIG. 10.

A determination as to whether another filter selection is received occurs at operation 814. If another filter selection is received, then the flow returns to operation 812 wherein the filter hints are updated.

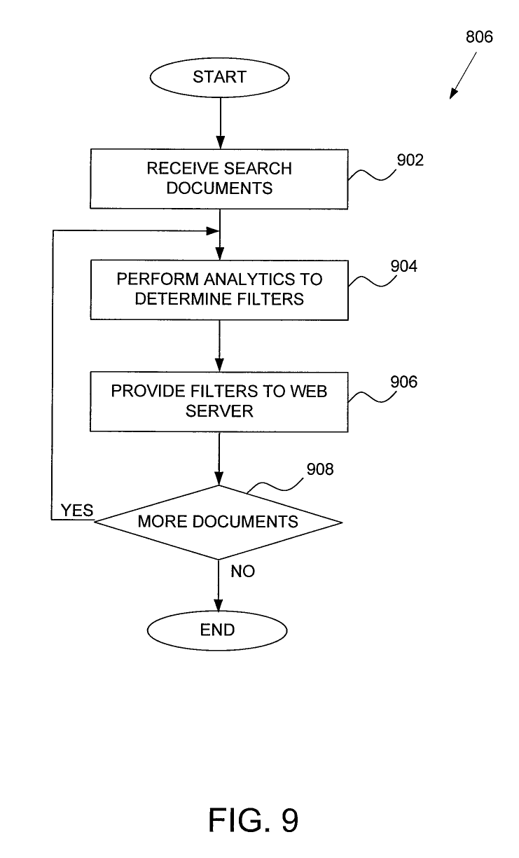

FIG. 9 is a flowchart of an example method to determine filters (e.g., operation 806). In example embodiments, the filters are determined by the analytics engine 216. At operation 902, search documents are received. In example embodiments, the search engine 214 initiates a search and in response documents are retrieved based on the search. Search documents are documents retrieved from performing the search. Examples of search documents include whitepapers, web pages, journal papers, newspaper articles, or any other collection of information or data that may be of interest to a user that is presentable via the client device.

As the documents are received, analysis is performed on each document to determine filters at operation 904. In example embodiments, advanced linguistics along with a rule set are applied to each document to determine filter items contained in each document. The filter items collectively identify the filters.

The filter and filter item information is then provided to the web server 202 at operation 906. In one embodiment, the filter and filter item information may be stored to a database (e.g., database 206), which is accessed by the web server 202. In an alternative embodiment, the filter and filter item information may be directly provided to the web server 202.

A determination as to whether more documents should be analyzed is performed at operation 908. If more documents are retrieved as search results, then the flow returns to operation 904.

FIG. 10 is a flowchart of an example method to determine the filter hints to be presented to a user at the user device 106 (e.g., operations 808 and 812). At operation 1002, a determination as to whether a filter group is expanded is performed. If a filter group is expanded, then a filter list within the expanded filter group is provided at operation 1004. If the search is still proceeding, the filter list displays the filters that are available within the filter group that have been found in a current result set. If the search is completed, the filter list may also provide a result count for each enabled filter.

At operation 1006, a determination is made as to whether a filter is selected. If a filter is not selected, then a result count may be determined and provided for each filter in the expanded filter group at operation 1008. However, if a filter is selected at operation 1006, then at operation 1010, a determination is performed to determine if a match-all or match-any mode is selected for the filter group. If the match-all mode is selected, then the result count may be determined and provided for each filter in the expanded filter group at operation 1008.

Alternatively, if the match-any mode is selected at operation 1010, then a total result count for each filter in the expanded filter group is determine at operation 1012, and a result count excluding the currently selected filter(s) is determined for each filter in the expanded filter group at operation 1014 (e.g., result count based on an original result set). Both result counts are then provided in operation 1016.

### Modules, Components, and Logic

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by, for example, cost, time, energy-usage, and package size considerations.

Accordingly, the term module should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Example Machine Architecture and Machine-Readable Medium

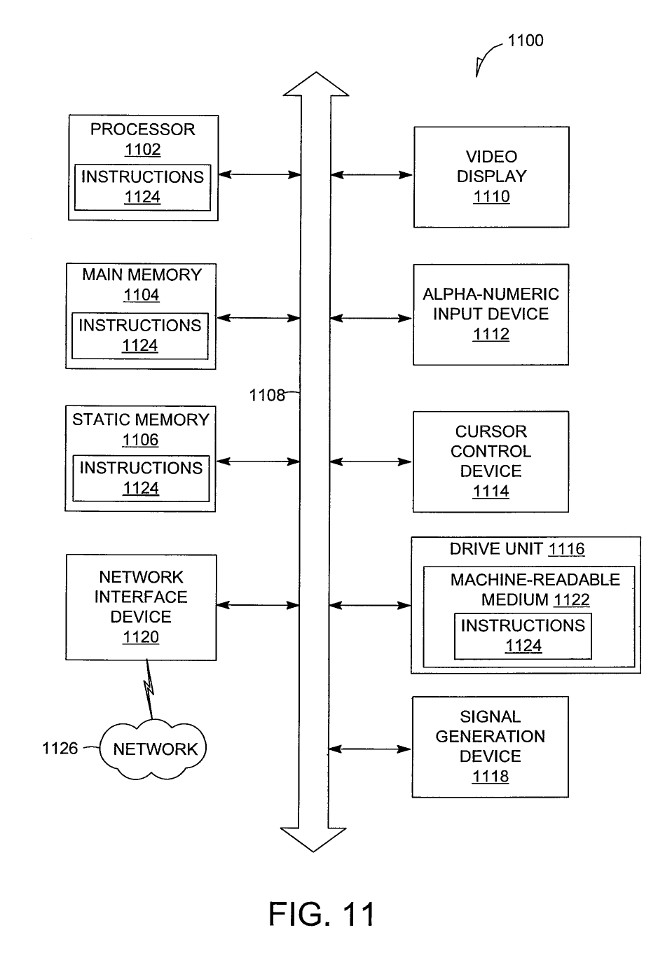

With reference to FIG. 11, an exemplary embodiment extends to a machine in the example form of a computer system 1100 within which instructions for causing the machine to perform any one or more of the methodologies discussed herein may be executed. In alternative exemplary embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1100 may include a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). In exemplary embodiments, the computer system 1100 also includes one or more of an alpha-numeric input device 1112 (e.g., a keyboard), a user interface (UI) navigation device or cursor control device 1114 (e.g., a mouse), a disk drive unit 1116, a signal generation device 1118 (e.g., a speaker), and a network interface device 1120.

### Machine-Readable Medium

The disk drive unit 1116 includes a machine-readable medium 1122 on which is stored one or more sets of instructions 1124 and data structures (e.g., software instructions) embodying or used by any one or more of the methodologies or functions described herein. The instructions 1124 may also reside, completely or at least partially, within the main memory 1104 or within the processor 1102 during execution thereof by the computer system 1100, the main memory 1104 and the processor 1102 also constituting machine-readable media.

While the machine-readable medium 1122 is shown in an exemplary embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable medium” shall accordingly be taken to include, but not be limited to, solid-state memories and optical and magnetic media. Specific examples of machine-readable media include non-volatile memory, including by way of exemplary semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Transmission Medium

The instructions 1124 may further be transmitted or received over a communications network 1126 using a transmission medium via the network interface device 1120 and utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific exemplary embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

As used herein, the term “or” may be construed in either an inclusive or exclusive sense. Additionally, although various example embodiments discussed focus on a specific network-based environment, the embodiments are given merely for clarity in disclosure. Thus, any type of electronic system, including various system architectures, may employ various embodiments of the search system described herein and is considered as being within a scope of example embodiments.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
analyzing, using one or more processors, documents to determine filters based on a rule set, the filters being organized into one or more filter groups;
determining a filter count for each filter, the filter count indicating, prior to selection of the filter, how many documents match the filter within a current result set, the current result set being a set of documents having any number of previously selected filters from the one or more filter groups applied thereto; and
providing the filters and filter counts to a user device, the filters including enabled filters and any disabled filters, disabled filters having a zero filter count in the current result set.

2. The method of claim 1, wherein the filter count further indicates how many documents match the filter from an original result set.

3. The method of claim 1, further comprising receiving a match-any mode selection for a filter group, the match-any mode selection combining selected filters within a same filter group with a Boolean “OR” operation.

4. The method of claim 1, further comprising receiving a match-all mode selection for a filter group, the match-all mode selection combining selected filters within a same filter group with a Boolean “AND” operation.

5. The method of claim 1, wherein providing the filters and filter counts to the user device comprises providing a visual indication for a collapsed filter group in which at least one filter has been selected.

6. The method of claim 1, wherein providing the filters and filter counts to the user device comprises providing the disabled filters graphically distinguished from the enabled filters.

7. The method of claim 1, wherein providing the filters and filter counts to the user device comprises providing rendering instructions to position the disabled filters at a bottom of a filter list in an expanded filter group.

8. The method of claim 1, further comprising providing the determined filters while a search is still being performed.

9. The method of claim 1, further comprising:
receiving a selection of a filter from one of the one or more filter groups, the selection updating the current result set; and
determining updated filters and filter counts for each updated filter based on the updated current result set.

10. The method of claim 9, wherein determining updated filters comprises determining enabled and disabled filters based on the updated current result set.

11. The method of claim 9, further comprising updating at least one view based on the updated filters and filter counts.

12. The method of claim 9, wherein determining updated filters and filter counts comprises running new SQL statements to retrieve data that provides the updated filter count based on the selection of the filter.

13. The method of claim 1, wherein providing the filters and filter counts to the user device comprises providing rendering instructions to render the filters and filter counts in a filter display section on a display device of the user device.

14. The method of claim 13, further comprising allowing a user of the user device to select one or more filters from the filter display section.

15. The method of claim 1, wherein providing the filters and filter counts to a user device comprises providing rendering instructions to a browser of the user device when polled by the browser.

16. A system comprising:
an analytics engine to analyze documents to determine filters, the filters being organized into one or more filter groups;
a filter hint module to determine a filter count for each enabled filter, the filter count indicating, prior to selection of the filter, how many documents match the filter within a current result set, the current result set being a set of documents having any number of previously selected filters from the one or more filter groups applied thereto; and
a communication module to provide the filters and filter counts to a user device, the filters including enabled filters and any disabled filters, disabled filters having a zero filter count in the current result set.

17. The system of claim 16, further comprising a search engine to process a search request using one or more search brokers to retrieve the documents.

18. The system of claim 16, further comprising a scheduled services engine to run a search in a background and notify a user when new results of a search are available.

19. A machine-readable storage medium in communication with at least one processor, the machine-readable storage medium storing instructions which, when executed by the at least one processor, provides a method comprising:
analyzing, using one or more processors, documents to determine filters, the filters being organized into one or more filter groups;
determining a filter count for each enabled filter, the filter count indicating, prior to selection of the filter, how many documents match the filter within a current result set, the current result set being a set of documents having any number of previously selected filters from the one or more filter groups applied thereto; and
providing the filters and filter counts to a user device, the filters including enabled filters and any disabled filters, disabled filters having a zero filter count in the current result set.

20. The machine-readable storage medium of claim 19, wherein providing the filters and filter counts to the user device comprises providing rendering instructions to position the disabled filters at a bottom of a filter list in an expanded filter group
